(19) United States
(12) Patent Application Publication
(10) Pub. No.: US 2015/0042577 A1
(43) Pub. Date: Feb. 12, 2015

(54) INFORMATION PROCESSING APPARATUS, INFORMATION PROCESSING METHOD, AND STORAGE MEDIUM

(71) Applicant: FUJI XEROX CO., LTD, Tokyo (JP)

(72) Inventor: Kiyoko SHIMADATE, Kanagawa (JP)

(73) Assignee: FUJI XEROX CO., LTD, Tokyo (JP)

(21) Appl. No.: 14/285,823

(22) Filed: May 23, 2014

(30) Foreign Application Priority Data
Aug. 7, 2013 (JP) 2013-163809

(51) Int. Cl. G06F 3/041

(52) U.S. Cl. CPC G06F 3/041
USPC 345/173

(57) ABSTRACT

An information processing apparatus includes a display controller configured to provide display control to allow a display range of a display to be moved relative to image information; a detector configured to detect a track of contact by an operator from an operation on a contact-sensitive operation unit, which is overlaid on the display; a determiner configured to determine whether or not the track detected by the detector meets or is similar to a predetermined pattern; and a movement processor configured to move the display range to a range of the image information, which is previously associated with the pattern, if the determiner determines that the track meets or is similar to the pattern.

### CROSS-REFERENCE TO RELATED APPLICATIONS

This application is based on and claims priority under 35 USC 119 from Japanese Patent Application No. 2013-163809 filed Aug. 7, 2013.

### BACKGROUND

The present invention relates to an information processing apparatus, an information processing method, and a storage medium.

### SUMMARY

According to an aspect of the invention, there is provided an information processing apparatus including a display controller configured to provide display control to allow a display range of a display to be moved relative to image information; a detector configured to detect a track of contact by an operator from an operation on a contact-sensitive operation unit, which is overlaid on the display; a determiner configured to determine whether or not the track detected by the detector meets or is similar to a predetermined pattern; and a movement processor configured to move the display range to a range of the image information, which is previously associated with the pattern, if the determiner determines that the track meets or is similar to the pattern.

### BRIEF DESCRIPTION OF THE DRAWINGS

Exemplary embodiment of the present invention will be described in detail based on the following figures, wherein:

FIG. 1 is a block diagram showing an example configuration of an information processing apparatus according to an exemplary embodiment;

FIGS. 2A to 2I are schematic illustrations each showing an example configuration of special pattern information;

FIG. 3A is a schematic illustration showing a content of image information, and FIGS. 3B to 3D are schematic illustrations each showing an example configuration of a display screen when part of image information is displayed in a display region on a display by a display controller;

FIG. 4A is a schematic illustration showing a content of image information, FIG. 4B is a schematic illustration showing an example configuration of a display screen when part of image information is displayed in a display region on the display by the display controller, and FIGS. 4C to 4E are schematic illustrations each showing an example configuration of a display screen when part of image information is displayed in a display region on the display by the display controller; and

FIG. 5 is a flowchart showing an operation example of the information processing apparatus.

### DETAILED DESCRIPTION

### Exemplary Embodiment

### Configuration of Information Processing Apparatus

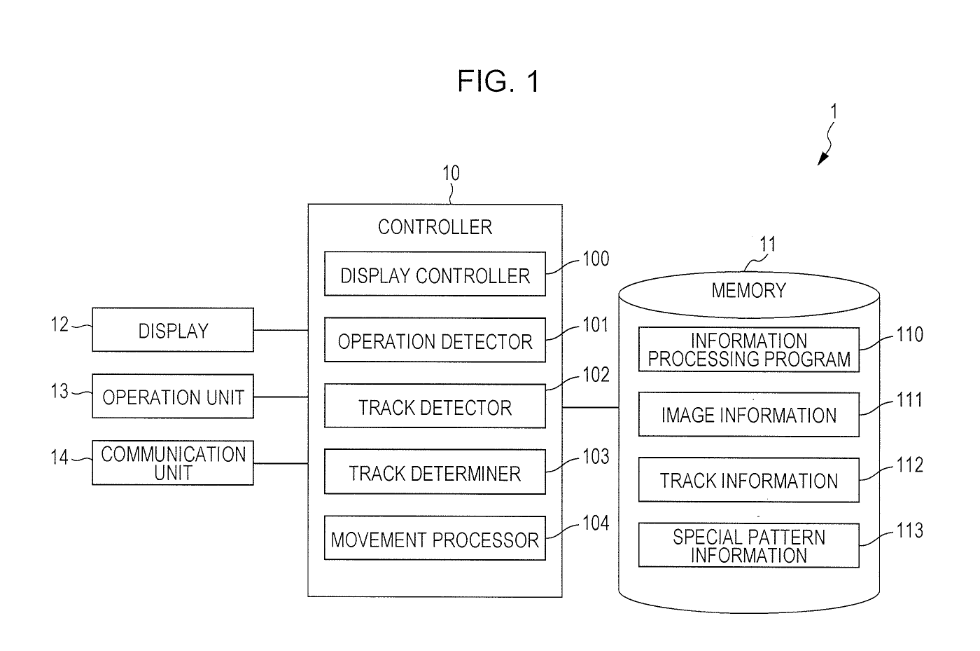

FIG. 1 is a block diagram showing an example configuration of an information processing apparatus according to an exemplary embodiment.

An information processing apparatus 1 includes a controller 10 that is formed of a central processing unit (CPU) or the like, controls respective units, and executes various programs; a memory 11 that is formed of a storage medium such as a flash memory, and stores information; a display 12 that displays characters, images, etc.; an operation unit 13 that is a contact-sensitive transparent touch pad overlaid on the display 12, and operates the information processing apparatus 1; and a communication unit 14 that communicates with an external device through a network.

When the controller 10 executes an information processing program 110 (described later), the controller 10 functions as, for example, a display controller 100, an operation detector 101, a track detector 102, a track determiner 103, and a movement processor 104.

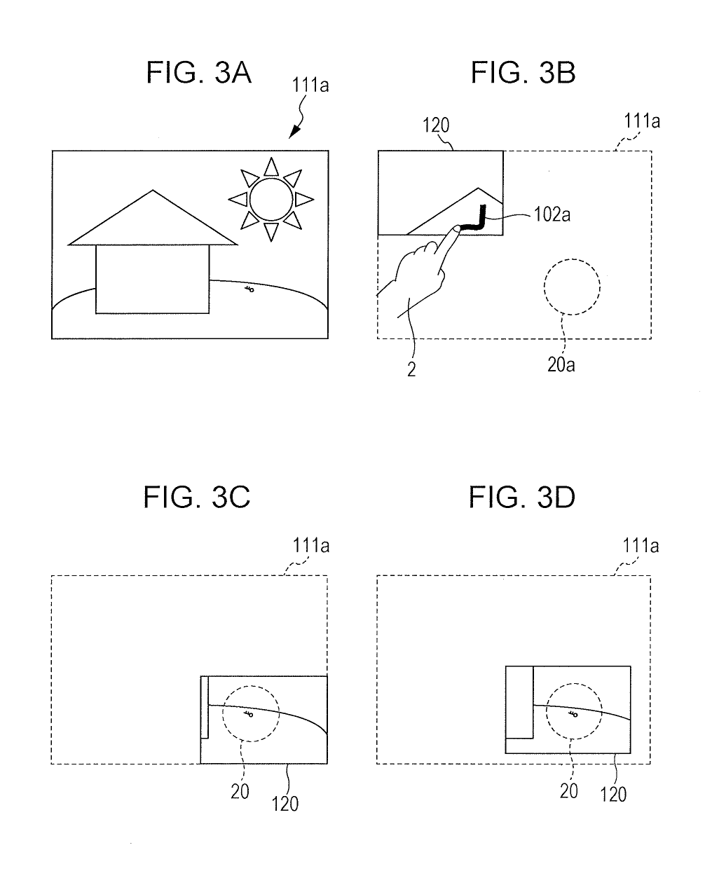

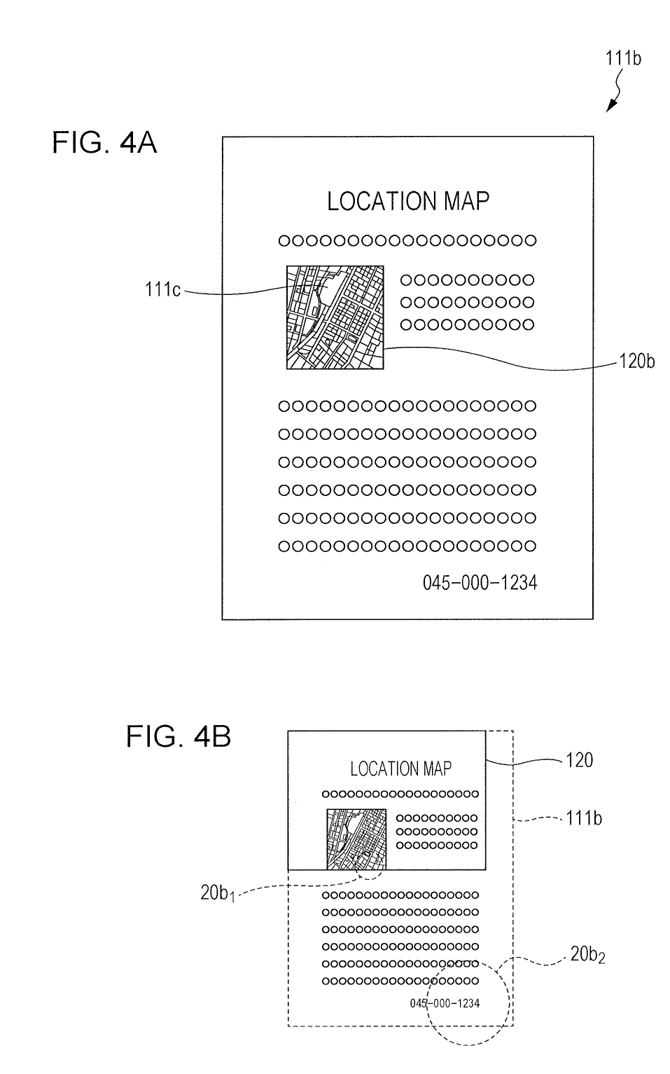

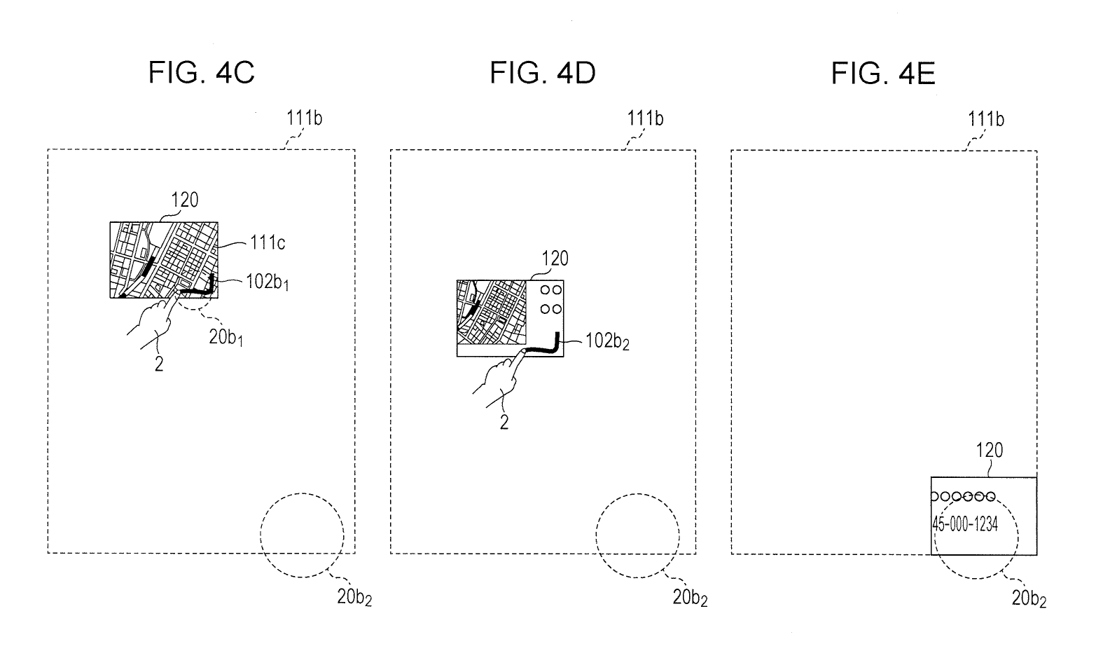

The display controller 100 displays image information 111, which is selected by an operator 2 (FIGS. 3A to 3D, and 4A to 4E), in a display region 120 (FIGS. 3A to 3D, and 4A to 4E) on the display 12. Also, the display controller 100 displays the image information 111 while moving and sizing the image information 111 based on processing of the movement processor 104 (described later) relative to the display region 120. The relationship between the image information 111 and the display region 120 is a relative relationship. Hereinafter, it is assumed that an expression “the image information 111 is moved relative to the display region 120” has a meaning similar to an expression “the display region 120 is moved relative to the image information 111.”

The operation detector 101 detects an operation content by the operator on the operation unit 13 while the display controller 100 displays the image information 111. The operation content to be detected may be, for example, a contacting operation on the operation unit 13 with a fingertip or other portion of the operator 13 (touch operation), a contacting and releasing operation (tap operation), a drawing operation (drag operation), a light stroke operation (flick operation), and a combination of these operations.

The track detector 102 detects a track mostly when the operation detector 101 performs a drag operation, and stores the track as track information 112 in the memory 11.

The track determiner 103 determines whether the track information 112 detected by the track detector 102 meets (is similar to) special pattern information 113 (described later) completely or within a predetermined threshold (hereinafter, simply expressed as “meet”). It is assumed that being similar contains a case in which patterns are geometrically similar to each other.

The movement processor 104 relatively moves the display range of the image information 111 displayed by the display controller 100, if the track determiner 103 determines that the track information 112 meets the special pattern information 113.

The memory 11 stores, for example, the information processing program 110, which causes the controller 10 to operate as the respective units 100 to 104, the image information 111, the track information 112, and the special pattern information 113.

An example, in which display control is executed on the image information 111, is described; however, any kind of information may be used instead of the image information 111, such as an HTML file, a text file, or a file created by spreadsheet software, as long as the information may be displayed on the display 12.

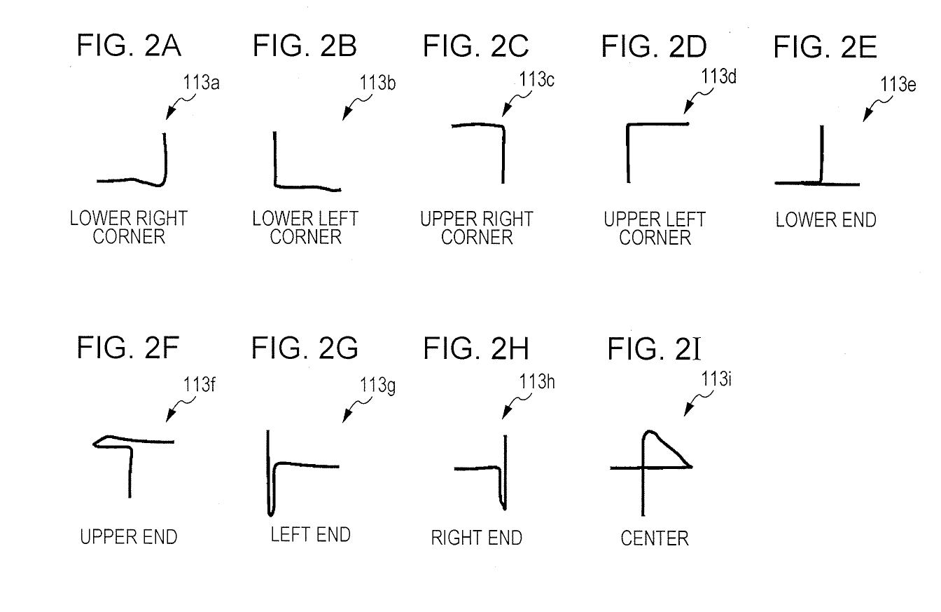

FIGS. 2A to 2I are schematic illustrations each showing an example configuration of the special pattern information 113.

If track information 112 which meets special pattern information 113a in FIG. 2A is input to the operation unit, the movement processor 104 moves the display range to the lower right corner of the image information 111. Special pattern information 113a to special pattern information 113i may be judged for meeting with regard to the stroke direction (for example, light sharp stroke from the upper side to the lower side, and then to the left), or may be judged regardless of the direction.

If track information 112 which meets special pattern information 113b in FIG. 2B is input to the operation unit, the movement processor 104 moves the display range to the lower left corner of the image information 111.

If track information 112 which meets special pattern information 113c in FIG. 2C is input to the operation unit, the movement processor 104 moves the display range to the upper right corner of the image information 111.

If track information 112 which meets special pattern information 113d in FIG. 2D is input to the operation unit, the movement processor 104 moves the display range to the upper left corner of the image information 111.

If track information 112 which meets special pattern information 113e in FIG. 2E is input to the operation unit, the movement processor 104 moves the display range to the lower end of the image information 111.

If track information 112 which meets special pattern information 113f in FIG. 2F is input to the operation unit, the movement processor 104 moves the display range to the upper end of the image information 111.

If track information 112 which meets special pattern information 113g in FIG. 2G is input to the operation unit, the movement processor 104 moves the display range to the left end of the image information 111.

If track information 112 which meets special pattern information 113h in FIG. 2H is input to the operation unit, the movement processor 104 moves the display range to the right end of the image information 111.

If track information 112 which meets special pattern information 113i in FIG. 2I is input to the operation unit, the movement processor 104 moves the display range to the center of the image information 111.

### Operation of Information Processing Apparatus

Next, an operation of this exemplary embodiment is described based on three sections including (1) Basic Operation, (2) Moving Operation with Special Pattern, and (3) Moving Operation Relative to Inside Display Object.

### (1) Basic Operation

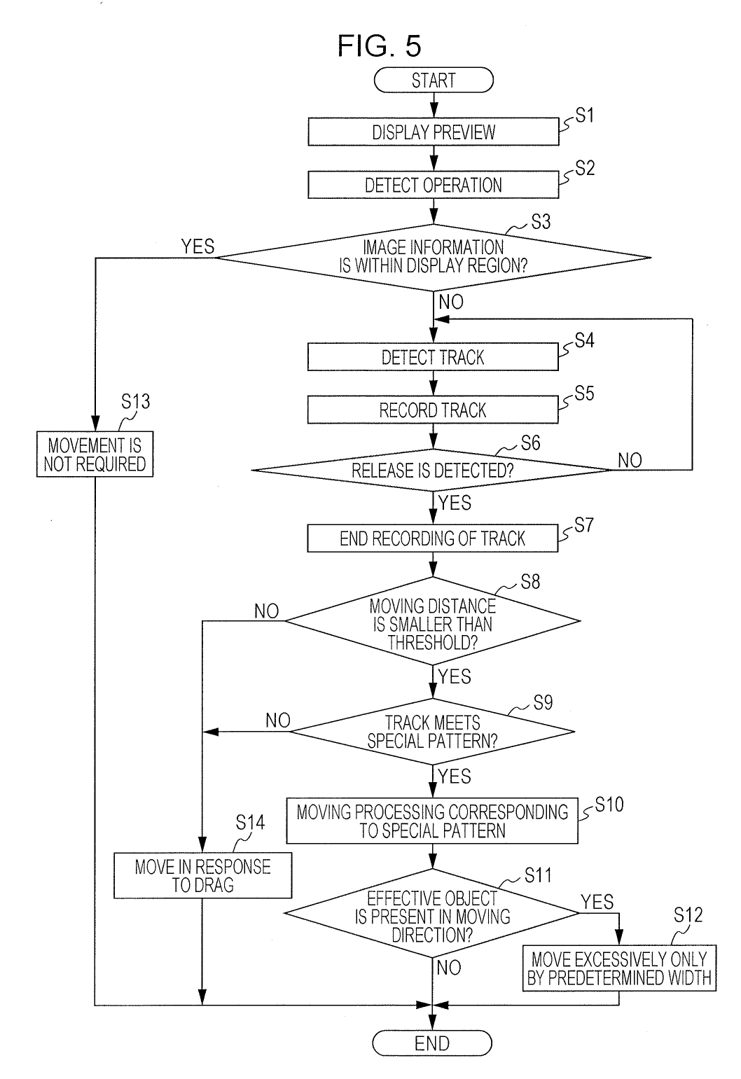

FIG. 5 is a flowchart showing an operation example of the information processing apparatus 1. Also, FIG. 3A is a schematic illustration showing a content of the image information 111. FIGS. 3B to 3D are schematic illustrations each showing an example configuration of a display screen when part of the image information 111 is displayed in the display region 120 on the display 12 by the display controller 100.

First, the operator 2 operates the operation unit 13 of the information processing apparatus 1, and selects the image information 111 desired to be displayed by the operator 2 (not shown). The following description is given based on an assumption that the selected image information 111 is image information 111a shown in FIG. 3A.

As shown in FIG. 3B, the display controller 100 of the information processing apparatus 1 displays the image information 111a, which is selected by the operator 2, in the display region 120 on the display 12 (S1). The example shown in FIG. 3B is a case in which the size of the display region 120 is smaller than the size of the image information 111a.

The operator 2 operates the operation unit 13 of the information processing apparatus 1, so as to change the position of the image information 111 relative to the display region 120 by a drag operation and to change the magnification by a drag operation (pinch operation) by increasing or decreasing the distance between two fingers.

The display controller 100 displays the image information 111 while moving and sizing the image information 111 relative to the display region 120, by operations of the operation detector 101, the track detector 102, the track determiner 103, and the movement processor 104. Hereinafter, in particular, the moving operation is described in detail.

(2) Moving Operation with Special Pattern

When the image information 111a is displayed as shown in FIG. 3B, it is assumed that a range 20a is a range desired to be checked by the operator 2 among the image information 111a. Then, to move the display region 120 to the lower right corner of the image information 111a, the operator 2 performs a drag operation on the operation unit 13 overlaid on the display region 120, so as to meet the special pattern information 113a.

The operation detector 101 of the information processing apparatus 1 detects the operation by the operator 2 on the operation unit 13 (S2). Since the image information 111a is not within the display region 120 as shown in FIG. 3B (S3; NO), the track detector 102 monitors the operation detected by the operation detector 101 over time and detects a track 102a (S4), and until the track detector 102 detects that the operator 2 releases the fingertip from the operation unit 13 (S6), the track detector 102 records the detected track 102a as the track information 112 in the memory 11 (S5, S7).

Then, if the moving distance of the track 102a is smaller than a predetermined threshold (S8; YES), the track determiner 103 compares the track information 112 corresponding to the track 102a with the special pattern information 113. If the track 102a meets the special pattern information 113a (S9; YES), the movement processor 104 executes moving processing corresponding to the special pattern information 113a, that is, moving processing of moving the display region 120 to the lower right corner of the image information 111a (S10).

With the moving processing, the content of the image information 111a displayed in the display region 120 by the display controller 100 becomes as shown in FIG. 3C.

Then, the operator 2 performs a drag operation on the operation unit 13 and hence moves the image information 111a to cause a range 20 to be located at the center of the display region 120.

The track determiner 103 determines that the track (not shown) corresponding to the operation does not meet any special pattern information 113 (S9; NO). The movement processor 104 moves the image information 111a to the position as shown in FIG. 3D in response to the drag operation (S14).

Also, in step S8, if the track determiner 103 determines that the moving distance of the track 102a is equal to or larger than the predetermined threshold (S8; NO), the movement processor 104 moves the image information 111a in response to the drag operation (S14).

In step S3, if the image information 111a is within the display region 120 (S3; YES), the movement processor 104 determines that the image information 111a is not required to be moved (S13).

The operator 2 checks the range 20 of the image information 111a.

### (3) Moving Operation Relative to Inside Display Object

Next, a case in which image information contains an inside display object which may be scrolled is described. The inside display object is described below in detail with reference to FIG. 4A.

FIG. 4A is a schematic illustration showing a content of the image information 111. FIGS. 4B, and 4C to 4E are schematic illustrations each showing an example configuration of a display screen when part of the image information 111 is displayed in the display region 120 on the display 12 by the display controller 100.

As shown in FIG. 4A, image information 111b has an inside display object 111c, such as a map that may be scrolled. By performing a drag operation on the inside display object 111c, the inside display object 111c may be moved relative to a display region 120b in the image information 111b.

First, when the operator 2 selects the image information 111b, the display controller 100 of the information processing apparatus 1 displays the image information 111b selected by the operator 2, in the display region 120 on the display 12 as shown in FIG. 4B.

When the image information 111b is displayed as shown in FIG. 4B, it is assumed that ranges 20b₁ and 20b₂ are ranges desired to be checked by the operator 2 among the image information 111b. To check the range 20b₁ first, the operator 2 performs a drag operation and a pinch operation so that the inside display object 111c is displayed in the display region 120 in an enlarged manner, and the display becomes a state in FIG. 4C. Then, the operator 2 checks the range 20b₁ of the image information 111b.

In the state shown in FIG. 4C, a drag operation by the operator 2 may move the display region 120b of the inside display object 111c, and it is difficult to move the display region 120 to the range 20b₂.

In this case, the operator 2 performs a drag operation with respect to the operation unit 13 overlaid on the display region 120, on the inside display object 111c, so that the drag operation meets the special pattern information 113a (track 102b₁).

Based on the above-described operation, similarly to “(2) Moving Operation with Special Pattern,” the information processing apparatus 1 executes steps S2 to S10. Since the image information 111b is present around the inside display object 111c, in step S11, the movement processor 104 determines that an effective object is present for the inside display object 111c, in a forward direction of moving processing (moving direction) (S11; YES), and the display region 120 is moved in the lower right direction only by an amount of a predetermined margin from the display region 120b and becomes a state shown in FIG. 4D (S12).

In the state shown in FIG. 4D, to move the display region 120 to the lower right corner of the image information 111b, the operator 2 performs a drag operation on the operation unit 13 overlaid on the display region 120, so as to meet the special pattern information 113a (track 102b₂).

Based on the above-described operation, similarly to “(2) Moving Operation with Special Pattern”, the information processing apparatus 1 executes steps S2 to S10, and as shown in FIG. 4E, the display region 120 is moved to the lower right corner of the image information 111b.

The operator 2 checks the range 20b₂ of the image information 111b.

### Other Exemplary Embodiments

The present invention is not limited to the above-described exemplary embodiment, and may be modified in various forms within the scope of the invention.

In the above-described exemplary embodiment, the functions of the respective units 100 to 104 of the controller 10 are provided by the program; however, the functions may be entirely or partly provided by hardware such as ASIC. Also, the program used in the above-described exemplary embodiment may be stored in a storage medium such as a CD-ROM and may be provided. Also, the steps described in the above-described exemplary embodiment may be changed in order, omitted, and/or added within the scope of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus, comprising:
a display controller configured to provide display control to allow a display range of a display to be moved relative to image information;
a detector configured to detect a track of contact by an operator from an operation on a contact-sensitive operation unit, which is overlaid on the display;
a determiner configured to determine whether or not the track detected by the detector meets or is similar to a predetermined pattern; and
a movement processor configured to move the display range to a range of the image information, which is previously associated with the pattern, if the determiner determines that the track meets or is similar to the pattern.

2. The information processing apparatus according to claim 1, wherein the movement processor moves the display range relative to the image information based on the track if the determiner determines that the track does not meet or is not similar to the pattern.

3. The information processing apparatus according to claim 1, wherein,
in response to that the image information has an inside display object,
the detector detects a track on the inside display object,
if the determiner determines that the track meets or is similar to the predetermined pattern, the movement processor provides moving processing to move the display range to a range of the inside display object previously associated with the pattern, and
if an effective display object is present in a moving direction, the movement processor provides moving processing to move the display range relative to the image information in the moving direction by an amount of a predetermined margin.

4. An information processing method comprising:
providing display control to allow a display range of a display to be moved relative to image information;
detecting a track of contact by an operator from an operation on a contact-sensitive operation unit, which is overlaid on the display;
determining whether or not the detected track meets or is similar to a predetermined pattern; and
moving the display range to a range of the image information, which is previously associated with the pattern, if it is determined that the track meets or is similar to the pattern.

5. A non-transitory computer readable medium storing a program causing a computer, which includes a display and a contact-sensitive operation unit overlaid on the display, to execute a process for information processing, the process comprising:
providing display control to allow a display range of the display to be moved relative to image information;
detecting a track of contact by an operator from an operation on the operation unit;
determining whether or not the detected track meets or is similar to a predetermined pattern; and
moving the display range to a range of the image information, which is previously associated with the pattern, if it is determined that the track meets or is similar to the pattern.
